(19) United States
(12) Patent Application Publication
(10) Pub. No.: US 2016/0022088 A1
(43) Pub. Date: Jan. 28, 2016

(54) SYSTEM AND METHOD FOR CLEANING A BEVERAGE PREPARATION MACHINE

(71) Applicant: Joshua Dick, Armonk, NY (US)

(72) Inventor: Joshua Dick, Armonk, NY (US)

(73) Assignee: Urnex Inc., Elmsford, NY (US)

(21) Appl. No.: 14/332,362

(22) Filed: Jul. 15, 2014

Related U.S. Application Data
(60) Provisional application No. 61/847,547, filed on Jul. 17, 2013.

(30) Foreign Application Priority Data
Jun. 9, 2013 (US) PCT/US2013/044862

(51) Int. Cl. A47J 31/60; B65D 17/50; B65D 8/00

(52) U.S. Cl. CPC A47J 31/60; B65D 11/02; B65D 17/502

(57) ABSTRACT

A beverage preparation machine cleaning system and method provides a range of human safe products that can easily be introduced into the machine and cycled through the equipment without the need to introduce product into the water reservoir or to disassemble the beverage preparation apparatus.

### CROSS-REFERENCE TO RELATED APPLICATIONS

This application is a continuation-in-part of International Patent Application No. PCT/US2013/044862, filed Jun. 9, 2013, and also claims the benefit of U.S. Provisional Patent Application No. 61/847,547 filed Jul. 17, 2013.

### FIELD

This invention relates generally to a cleaning system for a beverage preparation machine and, more particularly, to a method, formulation, and procedure for cleaning home or commercial beverage preparation or dispensing machines using container based cleaner delivery.

### BACKGROUND

During the past twenty years there has been a proliferation of single cup brewing machines by companies like Nespresso, Caffitaly, Kraft/Tassimo, Keurig, Krueger, Senseo, Lavazza and Illy, among many others around the world. Additional companies and products are anticipated to enter the field, including Starbuck's Verismo system. Many of these machines represent proprietary systems for brewing a single cup of coffee or espresso using coffee that has been prepared in a precise dose inside of a pressurized chamber. Each machine and system has its own shape of coffee capsule and its own brewing chamber. The brewing chambers of these machines typically include at least one needle or nozzle that pierces the capsule along with either a tube-like orifice, exit spout, or an embossed screen through which the coffee or other beverage is released after pressure, time or steam has been delivered.

Each brewing system enables a consumer to prepare a variety of beverages that have each been packaging in individual cups or capsules. These beverages range from coffee varieties to tea, milk, hot chocolate and soup. Almost any water soluble/extractable product can be run through these systems.

Consumers enjoy capsule based single serving brewing machines based on their ease of use, convenience, and ability to make one cup of a desired beverage at a time. Because these machines offer a variety of beverage options, consumers interchange different flavored items inside of the brewing mechanism. Each of these different flavored items takes the same pathway through the machine.

While most of the waste is contained in the capsule cup (hereinafter referred to simply as a capsule), the actual beverage is brewed and delivered through a common orifice. In many cases, the orifice is a small tube or needle that enables the pressurized (or unpressurized) beverage to flow into the capsule. Because consumers mix regular, flavored, and decaf coffee, hot chocolate, tea, milk products, and even soup through the same chamber, there is a need to eliminate contamination between the different beverages to avoid flavor comingling and ensure consistent taste. It is to be noted that the present innovation applies readily and as equally well to non-brewed beverage preparation and/or dispensing systems, such as soda machines, juice machines or a variety of other drink or liquid food preparation machines. In particular, the present cleaning system and method may be used to decontaminate virtually any beverage related machine.

On many machines the chambers and exit orifices can become clogged and blocked by beverage residue. On some systems both shelf stable liquid milk and powdered milk products are available in capsules and cups. These tend to build up more quickly and can also present a health and sanitation challenge.

Single cup coffee brewers span a range of different proprietary capsule sizes and brewing methods. Each system is slightly different. For example, there are two types of coffee that are typically available around the world. One is an American style filtered coffee. Such coffee is brewed through a filter or screen with water dripping or flowing over it, usually based on gravity. Examples of such system include the typically observed “Mr. Coffee” style or Bunn machines seen throughout the United States. The machine pours hot water over the ground coffee and the water then flows through the grounds with a filter separating the “elixir” from the grounds. Keurig capsule-based machines work in generally the same manner. The machine has a pump to push or pull the water to the high point and pour it over the coffee. Sometimes the water is delivered with some pressure but not as much as in those techniques described below. In some of the newer systems from Keurig there are also pressure driven systems and both horizontal and vertical placement of cups and capsules.

Another style of coffee is that made by the capsule systems is espresso. This style is available from Ily, Nespresso, Caffitally, K-Fee, Lavazza and Starbucks, with many other proprietary systems available and already in the market. In such systems, the coffee is brewed and extracted under pressure. This is how Italian style espresso is brewed. A small amount of water is forced through a small amount of finely ground coffee. In these situations, the machines may have a great deal of pressure, especially for home applications. This is why the Nespresso and espresso style machines are pressure brewers. They often use the metal foil to create a screen that allows pressurized coffee to push through. These machines more often tend to place the capsule into the system and brew horizontally while the classic filter/Keurig style brewer pours from above. In some cases, the capsules have plastic or metal filters built into the unit.

However, regardless of the type of brewing system and the orientation of the capsule, all share a common challenge of the need to clean certain pins, nozzles, needles, orifices, and exit screens that are only touched by liquids that flow through capsules along the same path as the coffee or other beverage being prepared. Typically, such brewing machines are marketed as having very few areas to clean. In actual practice, all suffer from issues with cross-contamination of different products. Each machine also has very elaborate instructions for disassembly and cleaning of the chambers and orifices. Unfortunately, even though these instructions are offered in manuals and online, the processes are time consuming and in many cases as many as eight or ten steps may be required. As such, consumers rarely engage in the cleaning process and often wait for the machine to become clogged, unsanitary, or simply break down.

As described above, most of these brewing systems have a delivery pin, needle, nozzle or exit screen through which coffee or other beverages flow. The pins or exit screens cannot be cleaned without first forcing water and cleaner through a capsule. Without the presence of a capsule, cleaning solution would bypass the needles, nozzles pins and screens, leaving them soiled and unclean. In addition, without placing the cleaner into a capsule, the machines pressure system will be bypassed and there will be no release or agitation of the cleaning solution. Currently, the process for cleaning these exit areas requires disassembly of the brewing chambers, poking and piercing with items such as paperclips, and time consuming and awkward processes.

### BRIEF DESCRIPTION OF THE DRAWINGS

The features of the present invention are set forth with particularity in the appended claims. The invention itself, together with further features and attendant advantages, will become apparent from consideration of the following detailed description, taken in conjunction with the accompanying drawings. An embodiment of the invention is now described, by way of example only, with reference to the accompanying drawings in which:

FIG. 1 shows a capsule containing cleaning materials;

FIG. 2A shows an alternately configured capsule having a filter and containing cleaning material;

FIG. 2B shows the capsule of 2A without the filter;

FIG. 3 shows a reusable capsule that may be filled with cleaning material;

FIG. 4 shows a reusable capsule that may be filled with solid cleaning material;

FIG. 5 shows an exemplary capsule having an exit screen from which cleaner exits;

FIG. 6 shows the capsule of FIG, 5 illustrating the exit of the cleaning material from the interior of the capsule; and

FIG. 7 shows an alternate embodiment of a capsule for holding cleaning material.

### DETAILED DESCRIPTION

Recognizing the need for a technique, method, and product for cleaning brewing machines, there is provided the process of cleaning capsule based single cup brewers effectively, easily, and conveniently using a self-contained cleaning product that can be delivered to the brewing chamber without the need to introduce product into the water reservoir or to disassemble the brew chamber or other parts of the brewing apparatus. Note that the term “brewing machine” may be used interchangeably with and to also broadly describe any beverage preparation or dispensing machine.

The present system has the novel ability to deliver cleaning powder, liquid, or gel into custom sized capsules, cups or containers that each fit the different “closed” systems of capsule brewing technology previously described. The cleaner is designed to dissolve within the capsule or cup during a single brew process, thereby eliminating the need to do anything more complicated than brew a beverage and repeat to rinse.

The cleaner is biodegradable, phosphate-free, and derived from plant and food based sources without any use of products derived from or through the use of petroleum products. However, traditional phosphate based product or other detergent formulation in the capsule also may be used. Delivery of a biocide or sanitizer product into the cup and capsule is also possible.

It is to be understood that a cleaner cannot simply clean the brewer by introducing the cleaning materials into the water reservoir of the machine and allowed to brew through the brewing chamber. Although it is known to introduce descaling agent, including vinegar, into the water reservoir of these machines, introducing a cleaner is ineffective at removing build-up on the brewing chamber and in the exit orifices and screens because of physics. The descaler is designed to touch the heating elements while the cleaner aims to contact the brewing exit areas and chamber.

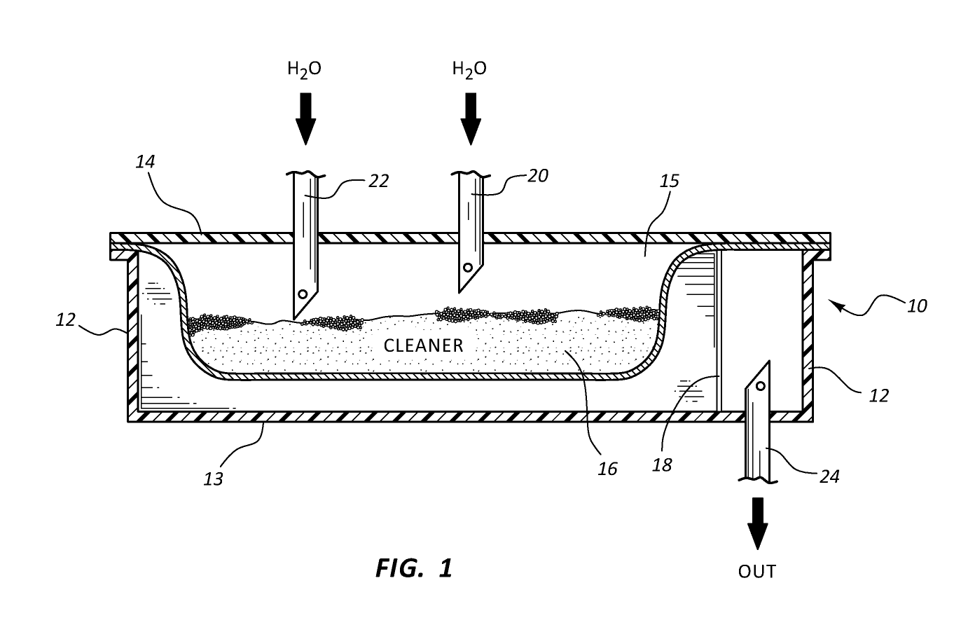

Referring to FIG. 1, there is shown a capsule 10 in a first aspect of the invention. The capsule 10 is formed of sidewalls 12, a bottom 13 and a cover 14. Within the capsule 10 there is at least one chamber 15 into which the cleaning materials 16 are placed. Note that although a liquid cleaning material is implied, the materials may be solid as well, including a powdered form. The cleaning material may also be in a gelatinous form. In an alternate embodiment, an optional filter 18 may be placed within the capsule 10 to capture any particulates. Although it is not expected that any particulates will be formed or found, it is possible that such particulates may be present as impurities in the cleaning liquid or as solids that may not have dissolved completely during the water and cleaning material mixing process as described below.

The cleaning materials are then mixed with water supplied by the ingress nozzles 20, 22 that penetrate the capsule during a brew cycle of the machine. The water then mixes with the cleaning materials 16 to create a cleaning solution that is then pushed through the exit orifice, such as a needle, nozzle or screen (hereinafter referred to as nozzle) 24. In the alternate embodiment, the cleaning solution is filtered by filter 18 prior to exiting through nozzle 24. A particular advantage of the present system over prior art approaches is that the cleaner is forced through the capsule into the chamber and follows the same path of the beverage, thereby contacting and cleaning these areas through which the various beverages travel. Cleaner brewed through a brewing chamber that is not originating in the capsule will bypass the exit nozzle through which the beverages are forced and will not clean the entire beverage path.

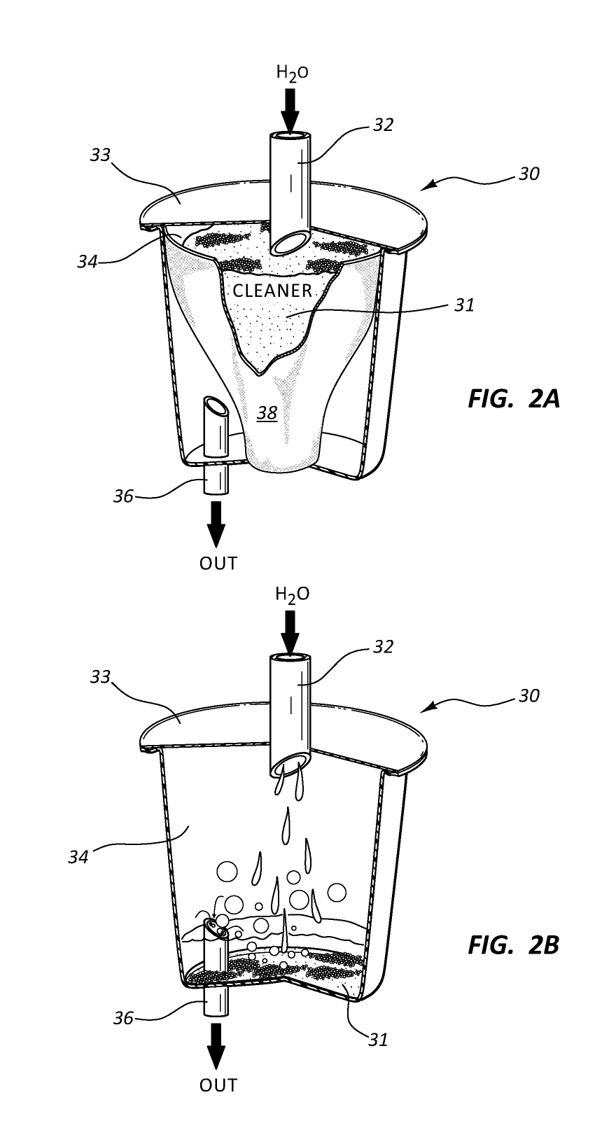

An alternate embodiment of the cleaning capsule is shown in FIGS. 2A and 2B. In this embodiment, the capsule 30 is configured to operate in those machines where a single water inlet 32 is present. The capsule 30 includes a chamber 34 for holding the cleaning materials 31 and a cover 33. Water is injected into the chamber 34 and mixes with the cleaning materials to create a cleaning solution. The solution is then ejected through the nozzle 36. An optional filter 38 (FIG. 2A) may be placed inside the capsule 30 to filter out any particles from entering the exit nozzle 36 in the event the cleaning material is a powder or solid that has not completely dissolved or if there are any impurities in the liquid cleaner

Depending on the system used by a particular manufacturer, there exist different demands from water flow rate, solubility, time, and the ways each system triggers brew. In some cases, the machine brewing system is pressurized. For these systems, it is important to balance the formula's foaming rate to avoid overflow and degass. In other systems where there is less pressure, the formula used in the capsule or cup must be designed to dissolve quickly and completely to avoid any residue of cleaner remaining in the brew chamber during and after rinse.

Although most existing single cup capsule based brewing systems utilize plastic, metal or paper cups and capsules, alternate embodiments use a paper filter type pod as well as biodegradable and environmentally responsible shapes and sizes. In addition, optionally, capsules are colored in a manner that clearly distinguishes them from the beverages otherwise offered in those same sizes and shapes. In another alternate embodiment, an insert for the brew chamber is used that may be a reusable carrier for an awkwardly shaped capsule. This eliminates the possibility of consumers ingesting cleaner by mistake.

In each form of the product, there exists the ability to add a food safe color indicator to make it clear to consumers that the product in their collection cup is not for consumption but rather cleaning solution.

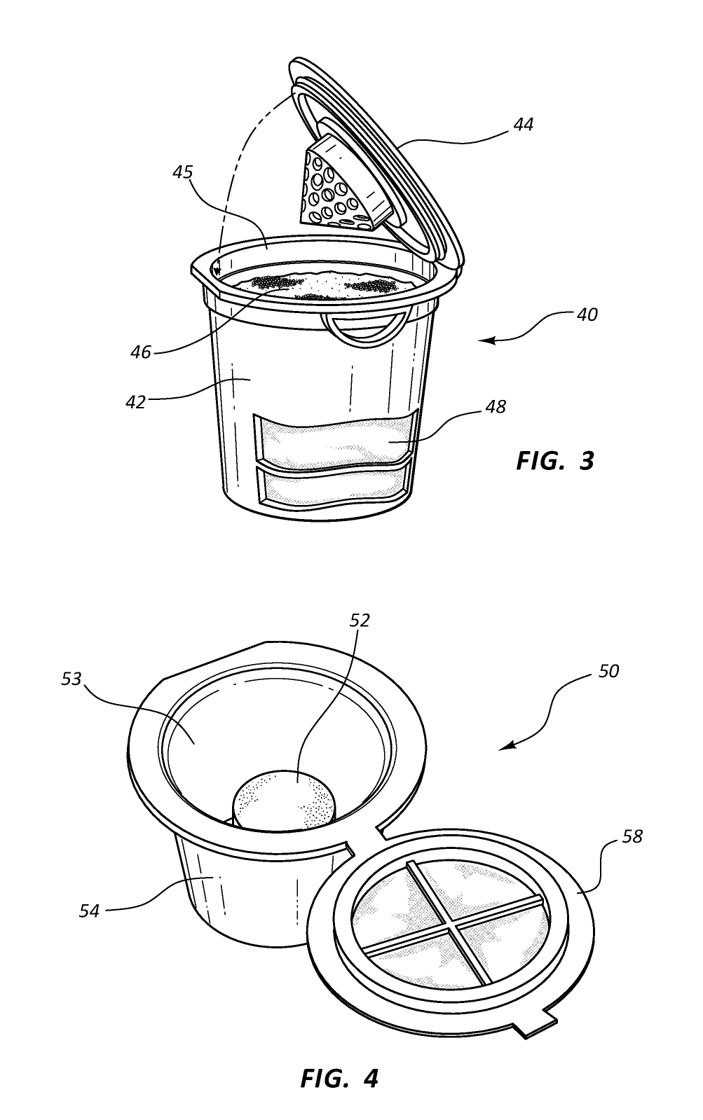

In other alternate embodiments as shown in FIG. 3, FIG. 4 and FIG. 7, a portioned powder or tablet can be used in a reusable cup/capsule system. In particular, many of the brewers described herein have hard plastic parts that allow a consumer to fill them with their own coffee. In such cases, the cleaners described herein can be loaded into these mechanisms and used repeatedly. It is to be noted that liquids and gels also may be utilized as the cleaning material form in most any capsule and cup system described herein in addition to being used in the reusable cup and capsule system shown.

For example, FIG. 3 illustrates a reusable capsule system 40 wherein the capsule 42 includes a removable or hinged lid 44. The lid 44 is lifted to reveal the chamber inside 45 that receives the powdered cleaning materials 46. Alternatively, a tablet, pill or pellet shaped cleaner is placed inside the cup 42. This allows for controlled dosing. Depending on the materials used and the form in which they are stored in the capsule, a filter 48 may or may not be necessary. For example, if liquid cleaner is placed inside the container, then a filter is not needed. On the other hand, if a powder or tablet is used, a filter may possibly be required to prevent residue from exiting the container into the exit nozzle of the brewer.

Referring now to FIG. 4, an alternate reusable capsule system 50 is shown wherein a tablet 52 may be placed inside the chamber 53 of the capsule 54. The capsule system 50 includes a removable or hinged lid 58 that is lifted off the capsule to enable the chamber to receive the tablet 52. The capsule also includes several orifices (not shown) that preclude the use of powdered or liquid cleaning materials. However, the tablet 52 enables the cleaning material to be placed conveniently inside the capsule without creating a mess from liquid or particles falling through the orifices. In operation, water is injected into the capsule 54 through one or more nozzles (not shown), which causes the tablet 52 to dissolve and create a cleaning solution that may then be forced through an exit nozzle (not shown). An optional filter may be provided to ensure that no particles of the tablet escape the capsule.

FIG. 7 shows another reusable cup/capsule system 60, which includes a lid 62 having a nozzle entry opening 68, an optional filter basket 64 and a funnel 66. In this system, the cleaning materials may be placed within the filtered basket 64, which is then placed inside the funnel 66. In operation, a nozzle for supplying water is placed through the nozzle entry opening 68. The water then mixes with the cleaning materials to create a cleaning solution which is then expelled through the funnel nozzle 70.

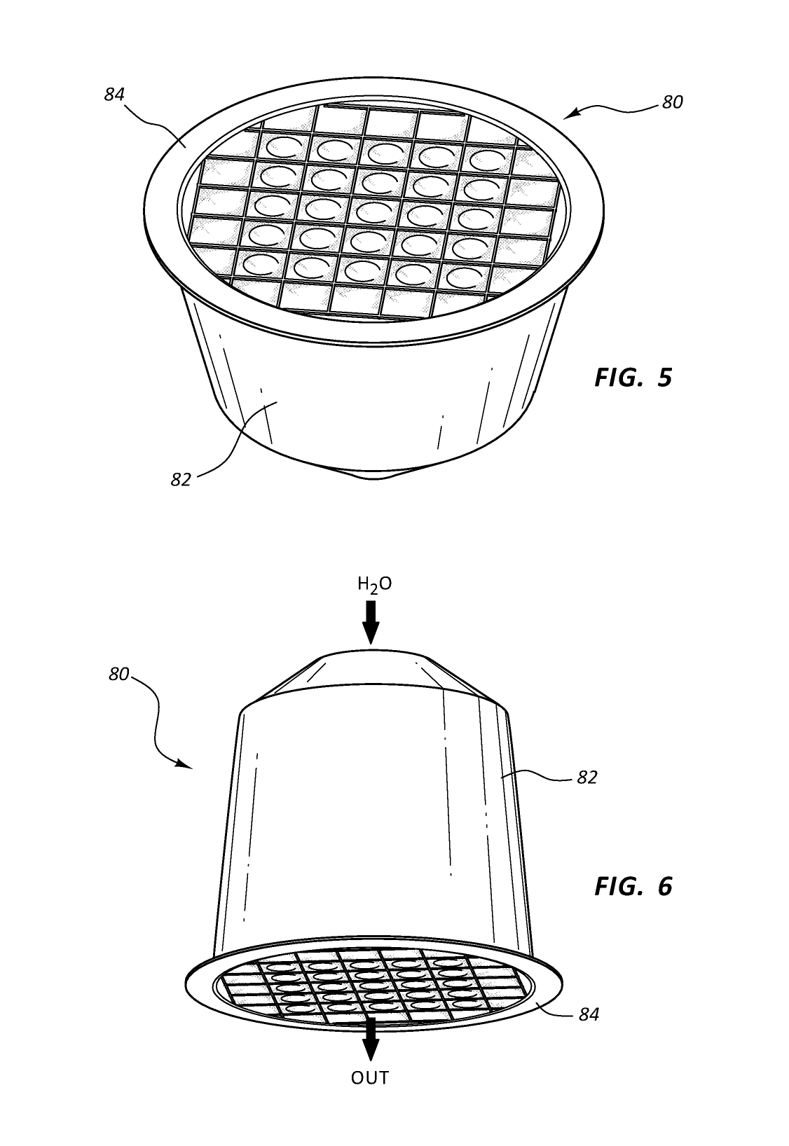

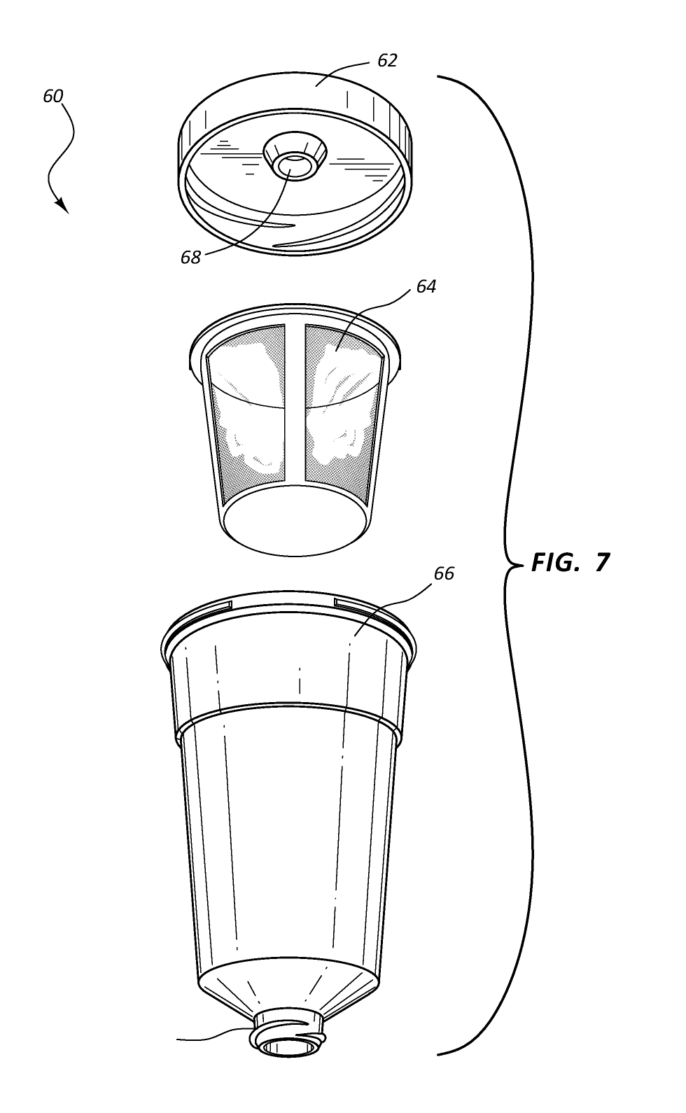

Turning now to FIG. 5 and FIG. 6 there is show an alternate capsule system 80 that includes a capsule 82 with an exit screen 84. A water supply nozzle (not shown) pierces the capsule 82 and provides water into the capsule for mixing with the cleaning materials to create a cleaning solution. Pressure is then used to force the cleaning material through the exit screen 84.

The use of the foregoing cleaning materials and capsule configurations results in a substantially simple method for cleaning a capsule based brew machine. In contrast, current advice from machine manufacturers such as Keurig offers an elaborate process for brew chamber cleaning.

The Keurig regimen includes an 8-step program that must be completed manually by the end user or consumer. First, the capsule holder must be removed from the brewing machine. Second, a funnel like device, which is part of the capsule holder, must be forcefully pried away from the capsule holder. Third, the hole on the bottom of the exit needle located on the capsule holder must be scraped clean using the end of a straightened paperclip. Fourth, the capsule holder or capsule cup and funnel must be rinsed off using running water to loosen and remove particles. Fifth, the lid of the brewer is raised to uncover the entrance needle. Sixth, the entrance needle is scraped using the straightened paperclip. Seventh, the capsule older and funnel are reassembled and placed back inside the brewing machine. Eighth, a water only brewing cycle is run without using a capsule. The entire process takes approximately ten minutes to complete. In the fifteen years since the Keurig machines were introduced, the need for cleaning the nozzles has existed. Yet during that entire time, until now, only primitive time-consuming cleaning methods like that described above have been available.

However, the new and novel system described herein eliminates the need to do any of the steps outlined above, resulting in a significant reduction of time and manual effort. In summary, the operator need only take a cleaning capsule, place it into a capsule cup and then place the capsule cup inside the brewer with a catch vessel below. Next, the machine operator runs a brew cycle for the largest serving offered and catches and discards the waste. The process is repeated with the same (now empty) capsule in place to rinse. The consumer then simply discards the capsule, brews again with nothing in place and returns the machine to service enjoying the next cup from a capsule of the beverage of choice. In some cases the machine will discard the capsule after first brewing. In this situation, it is envisioned that rinse maybe accomplished by an empty capsule with no cleaner or simply brewing a coffee or other beverage and discarding this first cup.

In an alternate process, the consumer desires to clean the brewer but prefers to do so without the use of any cleaning materials except water. This is accomplished by executing the steps described above, but substituting an empty capsule for the capsule containing cleaning materials. When the brew cycle is executed, water alone is pushed through the exit orifice in order to clean the pins, nozzles, needles, orifices, and/or exit screens. The process may be repeated with the capsule already in place to further rinse the machine or by brewing a coffee or other beverage and discarding the first cup produced.

It can be seen that regardless of the system employed, the machine cleaning process is literally as simple as running several brew cycles. There is no need for any specialized tools, improvised or otherwise, to clean the brewer.

While the ease of use of the present system is a very clear advantage over prior art cleaning methods, the time saved is also very significant as is the opportunity that this capsule system will encourage consumers to clean their brew chambers for better tasting beverages. In actual daily usage, few consumers follow the long and difficult cleaning processes described by the machine manufacturers. It is also possible that having a chamber disassembled will lead to loss of parts and challenges of reassembly. Finally, the use of the prepackaged cleaning capsule prevents the risk of a consumer cutting or injuring themselves on the exit needle, which is very sharp and exposed.

Although each proprietary machine and system is somewhat different from the other, cleaning is accomplished in a generally similar manner. In operation, a self-contained capsule, container cup or disc that holds the precise amount of cleaning agent is packaged inside an easily identifiable cup. Each cup or capsule is the size and shape of the cups and capsules that are offered for brewing and preparing selected beverages. At different periods in the life of a machine as frequently or rarely as a consumer pleases, a cleaning process is initiated. It is anticipated that the machines will eventually recommend via digital display or other indicator the use of these cleaning capsules at set intervals of drink making.

The consumer may also elect to use a cleaning cup/capsule after enjoying a hot chocolate or a flavored coffee before returning to service to make coffee or tea whose flavors could be compromised by cross-contamination. The cleaning capsules are configured for easy and simple use such that consumers will choose the frequency of leaning based on convenience and beverage selection. In a certain aspect, the capsules become purge mechanisms.

The actual physical operation of the new and novel cleaning system is now described in detail. Once a cleaning cycle is initiated, the brewing device is loaded with a capsule and a normal brew process begins at the consumer's request. Water is pushed into the capsule that is held in place within the machine's brew chamber. The hot water otherwise used to prepare a beverage dissolves the cleaning product inside of the chamber and causes a solution to be made inside of the capsule. At the machine's initiation, the liquid solution created by mixing water and cleaner is pushed out the exit orifice or through the brew screen, thereby cleaning all areas where coffee or other prepared beverages normally flow. Because the powder in the capsule is completely dissolved within the brew cycle of the largest beverage each machine can prepare, the consumer simply brews rinse water twice through the machine directly through the discharged capsule. This ensures a thorough rinse of the brew chamber and the exit orifice. The machine is then returned to normal service.

In an alternate embodiment (not shown), wherein the beverage preparation machine does not have an egress nozzle (exit needle/nozzle, etc.) or it is desired that the chamber in which the capsule sits is cleaned, the capsule may be configured such that an ingress nozzle or other means of introducing liquid into the capsule causes the capsule to release its contents into the chamber itself. Accordingly, the capsule is configured such that any liquid introduced into the capsule exits through the sidewalls, bottom, or top of the capsule and not through the exit needle.

While the present system and method for cleaning a brewing machine has been described in conjunction with a specific embodiment thereof, it is evident that many alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. A cleaning container for a beverage preparation machine, comprising:
an impermeable housing having a bottom, sidewalls extending upwardly from the bottom, and a top opening defined by the sidewalls;
an impermeable cover for covering the top opening for sealing the housing,
wherein the impermeable cover is piercable to receive an injection of liquid into the housing and wherein the bottom of the impermeable housing is piercable for enabling the egress of the liquid from the housing.

2. The cleaning container of claim 1, further including a filter placed within the housing for preventing particulates from exiting the housing along with the liquid.

3. A method for cleaning a beverage preparation machine having a liquid ingress nozzle and a liquid egress nozzle, comprising the steps of:
providing a container having an encapsulating cover;
inserting the container into the beverage preparation machine;
executing an operating cycle on the beverage preparation machine;
injecting liquid into the container using the ingress nozzle; and
ejecting the liquid out of the container through the egress nozzle.

4. The method of claim 3, further comprising the step of:
filtering the liquid to capture particulates prior to ejecting the liquid.

5. A cleaning container for a beverage preparation machine, comprising:
n impermeable capsule forming a housing, wherein the impermeable capsule is configured to receive a first nozzle for receiving an injection of liquid into the housing and wherein the impermeable capsule is configured to receive a second nozzle for enabling the egress of the liquid from the housing.

6. The cleaning container of claim 5, wherein the capsule is reusable.

7. The cleaning container of claim 5, wherein the capsule includes a filter for preventing particulates from exiting the housing.

8. The beverage preparation machine of claim 7, wherein the filter is removable.

9. A cleaning container for a beverage preparation machine, comprising:
an impermeable capsule forming a housing for placement in a chamber, wherein the impermeable capsule is configured to receive liquid under pressure into the housing and wherein the impermeable capsule is configured to enable the egress of the liquid from the housing into the chamber.
